(19) United States
(12) Patent Application Publication
(10) Pub. No.: US 2020/0041988 A1
(43) Pub. Date: Feb. 6, 2020

(54) DISPLAY METHOD, DISPLAY DEVICE, AND PROGRAM

(71) Applicant: NEC Corporation, Minato-ku, Tokyo (JP)

(72) Inventor: Masanao NATSUMEDA, Tokyo (JP)

(73) Assignee: NEC Corporation, Minato-ku, Tokyo (JP)

(21) Appl. No.: 16/340,800

(22) PCT Filed: Oct. 21, 2016
(86) PCT No.: PCT/JP2016/081293

§ 371 Date: Apr. 10, 2019

(51) Int. Cl. G05B 23/02; G06F 16/28

(52) U.S. Cl. CPC G05B 23/0221; G06F 16/285

(57) ABSTRACT

A display device is provided with: a history information generation part that determines, as an abnormal sensor, a sensor having an abnormal value with respect to each of a plurality of sensors provided in a target; a clustering part that clusters the determined abnormal sensor(s) to belong to any of a plurality of groups; a cluster hierarchical structuring part that determines a hierarchy among the plurality of groups; and an output part that associates, with the abnormal sensor(s), symbol(s) capable of differentiating groups to which the abnormal sensor(s) belongs, and uses the symbols to present to a user the abnormal sensor(s) together with information indicating hierarchical relationships among groups.

### TECHNICAL FIELD

The present invention relates to a display method, a display device and a program, and in particular relates to a display method, a display device and a program, which analyze a state of a system.

### BACKGROUND

In recent years, use is being made of system analysis devices that analyze system state based on sensor data obtained from system component elements. Analysis processing by this type of system analysis device is performed with the aim of operating a system safely and efficiently. An example of this analysis processing is processing to detect a system abnormality by multivariate analysis of sensor data. In this type of analysis processing, on detecting a system abnormality, the system analysis device gives notification of the abnormality occurrence to an operator and to the system. As a result, an abnormality or prior warning of an abnormality can be detected at an early stage, and a countermeasure action can be expedited to minimize damage.

As target systems for analysis processing, for example, assemblies or structures formed from elements that mutually affect each other, such as an ICT (Information and Communication Technology) system, a chemical plant, a power plant, power equipment or the like are cited.

It is to be noted that in system analysis devices, where a system analysis device detects a system abnormality, information contributing to identifying a cause may be provided. As an item of provided information, the name of a sensor related to the abnormality may be cited. Patent Literatures 1 and 2 disclose technology for giving notification of the sensor name related to an abnormality in this way, to an operator and the system.

Specifically, a process monitoring diagnosis device disclosed in Patent Literature (PTL) 1 provides the name of a sensor with a high abnormality degree at a point in time at which a system analysis device detects an abnormality, as a sensor name related to the abnormality.

A time series data processing device disclosed in Patent Literature 2 assumes an abnormality propagation order from time series data in a fixed period, and rearranges and provides sensor names related to an abnormality in the assumed abnormality propagation order.

Patent Literature 3 describes technology in which, in a case where performance information does not satisfy a relationship indicated by a correlation function, the occurrence of a malfunction is appropriately detected by extracting a period for the state in question as the malfunction period.

Patent Literature 4 describes technology in which abnormality detection is performed by using output signals of sensors attached to a facility, and a network of each sensor signal is created from information on the degree of influence on abnormality of each sensor signal.

Patent Literature 5 describes technology in which sensor data with strong mutual relationships in behavior are collected and grouped, and link models representing mutual relationships among data items within a group and mutual relationships between groups are built.

### CITATION LIST

### Patent Literature

### [PTL 1]

Japanese Patent Kokai Publication No. JP2014-096050A

### [PTL 2]

Japanese Patent Kokai Publication No. JP2014-115714A

### [PTL3]

International Publication No. WO2010/032701

### [PTL4]

Japanese Patent Kokai Publication No. JP2013-041448A

### [PTL5]

Japanese Patent Kokai Publication No. JP2011-243118A

### SUMMARY

### Technical Problem

The entire disclosed contents of the abovementioned Patent Literatures 1 to 5 are incorporated herein by reference thereto. The following analysis is given according to the present inventor.

With the devices disclosed in Patent Literatures 1 to 5, in a case of detecting events that include plural types of abnormality and prior warning of abnormality, there is a risk of the plurality of detected events being mixed up when outputted. Therefore, according to the devices disclosed in Patent Literatures 1 to 5, in the case in question, there is a problem of an operator not being able to appropriately comprehend system states.

Therefore, in a system to be analyzed, where a plurality of events occurs, a problem is to separate the respective events and output information corresponding to the respective events. It is an object of the present invention to provide a display method, a display device and a program, which contribute to solving the problem in question.

### Solution to Problem

According to a first aspect of the present invention, a display method includes: determining, as an abnormal sensor, a sensor having an abnormal value with respect to each of a plurality of sensors provided in a target; clustering the determined abnormal sensor(s) to belong to any of a plurality of groups; determining a hierarchy among the plurality of groups; and associating, with the abnormal sensor(s), symbol(s) capable of differentiating groups to which the abnormal sensor(s) belongs, and using the symbol(s) to present to a user the abnormal sensor(s) together with information indicating hierarchical relationships among groups.

According to a second aspect of the present invention, a display device includes: a history information generation part that determines, as an abnormal sensor, a sensor having an abnormal value with respect to each of a plurality of sensors provided in a target; a clustering part that clusters the determined abnormal sensor(s) to belong to any of a plurality of groups; a cluster hierarchical structuring part that determines a hierarchy among the plurality of groups; and an output part that associates, with the abnormal sensor(s), symbol(s) capable of differentiating groups to which the abnormal sensor(s) belongs, and uses the symbol(s) to present to a user the abnormal sensor(s) together with information indicating hierarchical relationships among groups.

According to a third aspect of the present invention, a program executes on a computer: a process of determining, as an abnormal sensor, a sensor having an abnormal value with respect to each of a plurality of sensors provided in a target; a process of clustering the determined abnormal sensor(s) to belong to any of a plurality of groups; a process of determining a hierarchy among the plurality of groups; and a process of associating, with the abnormal sensor(s), symbol(s) capable of differentiating groups to which the abnormal sensor(s) belongs, and using the symbol(s) to present to a user the abnormal sensor(s) together with information indicating hierarchical relationships among groups.

It is to be noted that the program may be provided as a program product recorded in a non-transitory computer-readable storage medium.

### Advantageous Effects of Invention

According to the display method, the display device and the program according to the present invention, in a system to be analyzed, where a plurality of events occur, it is possible to separate the respective abnormalities and output information corresponding to the respective events.

### BRIEF DESCRIPTION OF THE DRAWINGS

FIG. 1 is a block diagram showing an example of a configuration of a display device according to an exemplary embodiment.

FIG. 2 is a block diagram showing a schematic configuration of the display device according to a first exemplary embodiment.

FIG. 3 is a block diagram showing an example of a specific configuration of the display device according to the first exemplary embodiment.

FIG. 4 is a diagram showing an example of an output result by the display device according to the first exemplary embodiment.

FIG. 5 is a diagram showing an example of an output result by the display device according to the first exemplary embodiment.

FIG. 6 is a diagram showing an example of an output result by the display device according to the first exemplary embodiment.

FIG. 7 is a diagram showing an example of an output result by the display device according to the first exemplary embodiment.

FIG. 8 is a diagram showing an example of an output result by the display device according to the first exemplary embodiment.

FIG. 9 is a flow chart showing an example of operations of the display device according to the first exemplary embodiment.

FIG. 10 is a block diagram showing an example of a specific configuration of the display device according to a second exemplary embodiment.

FIG. 11 is a flow chart showing an example of operations of the display device according to the second exemplary embodiment.

FIG. 12 is a block diagram showing an example of a configuration of a computer that realizes the display device according to the first and second exemplary embodiments.

### MODES

First, a description is given concerning an outline of an exemplary embodiment. It is to be noted that reference symbols in the drawings attached to this outline are examples for the purpose of aiding understanding, and are not intended to limit the present invention to modes illustrated in the drawings.

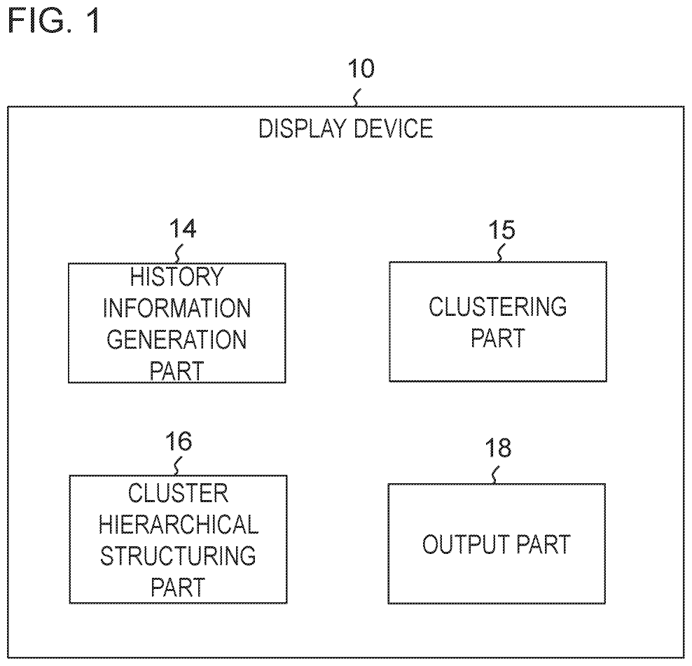

FIG. 1 is a block diagram showing an example of a configuration of a display device 10 according to an exemplary embodiment. Referring to FIG. 1, the display device 10 is provided with a history information generation part 14, a clustering part 15, a cluster hierarchical structuring part 16, and an output part 18.

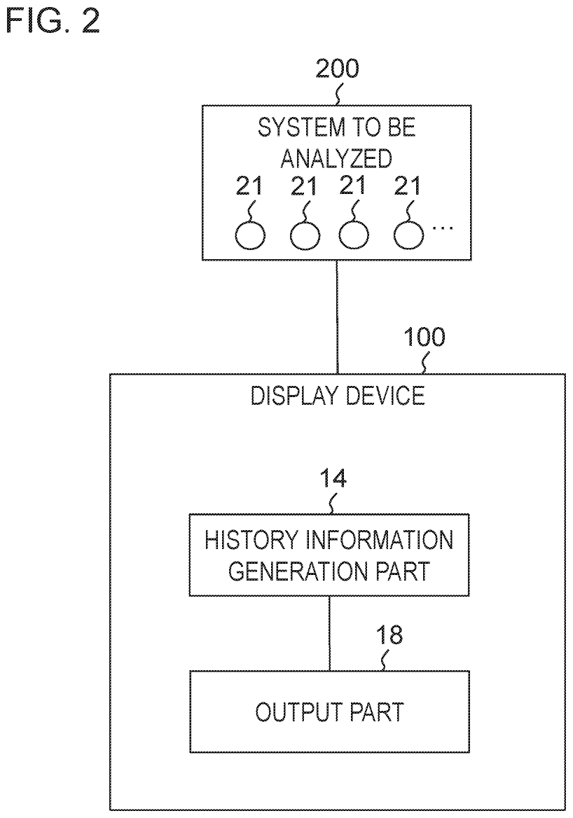

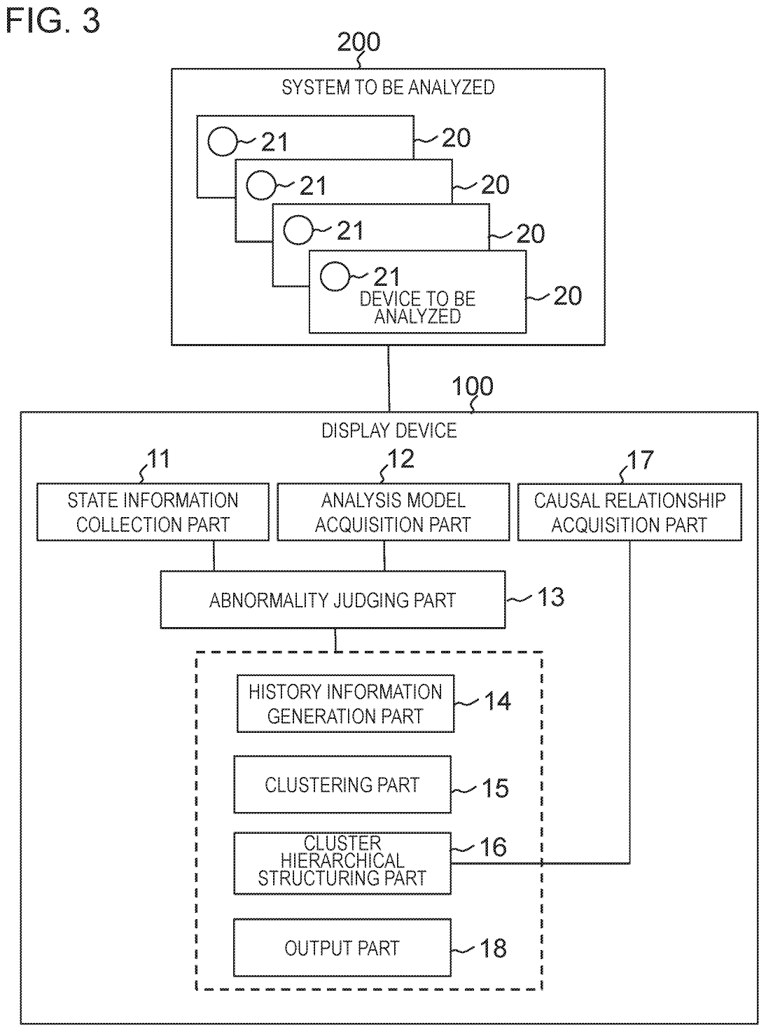

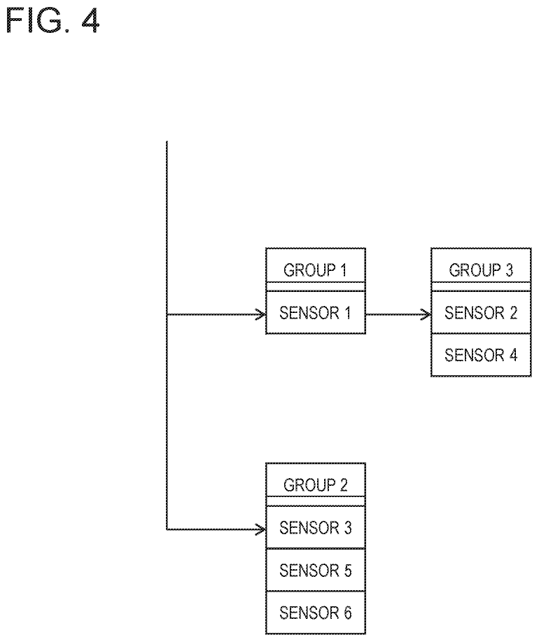

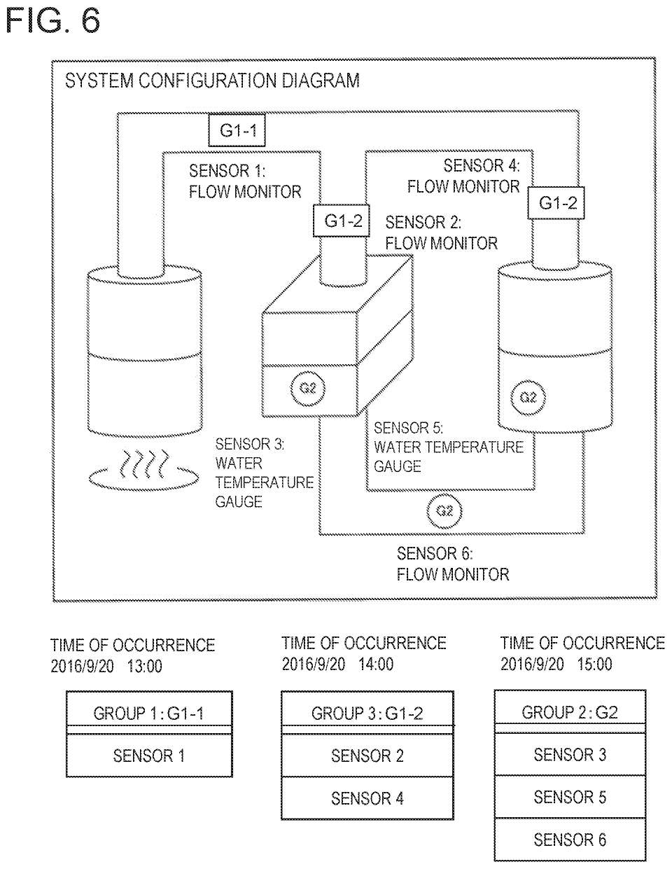

The history information generation part 14 determines, as an abnormal sensor, a sensor having an abnormal value with respect to each of a plurality of sensors (for example, sensors 21 in FIG. 2, FIG. 3) provided to a target (for example, system 200 that is to be analyzed in FIG. 2, FIG. 3). The clustering part 15 performs clustering so that the determined abnormal sensor(s) belongs to any of a plurality of groups (for example, group 1 to 3 in FIG. 4 to FIG. 6). The cluster hierarchical structuring part 16 determines a hierarchy (for example, FIG. 4) among the plurality of groups. The output part 18 associates, with the abnormal sensor(s), a symbol(s) enabling the group to which the abnormal sensor(s) belongs to be distinguished (for example, marker G1-1, G1-2, G2, etc. in FIG. 6), and, using the symbol(s), presents to a user the abnormal sensor(s) along with information indicating hierarchical relationship of the groups.

According to the display device 10, a sensor group obtained from sensor history information based on sensor values, and hierarchical structure of the group, are presented to the user. At this time, the plurality of sensors are separated into groups according to events. Therefore, according to the present exemplary embodiment, in a system to be analyzed, where a plurality of events occur it is possible to separate the respective events and to output information corresponding to the respective events. Furthermore, by the groups being hierarchically structured, even where events caused in a chain, due to an event due to one basic cause, are obtained as a plurality of groups, it is possible to comprehend the causal relationship as a group hierarchical structure. Therefore, an operator can more accurately comprehend the system state.

Below an “abnormality in a sensor value outputted by a sensor” and “(abnormality in) sensor value outputted by a different sensor” are respectively referred to as simply “sensor abnormality” and “(abnormality in) relationship among sensors”.

### First Exemplary Embodiment

Next, a description is given concerning the display device, the display method, and the program according to a first exemplary embodiment, making reference to FIG. 2 to FIG. 9.

### <Configuration>

First, a description is given concerning a schematic configuration of the display device in the present exemplary embodiment making reference to FIG. 2. FIG. 2 is a block diagram showing an example of a schematic configuration of a display device 100 according to the exemplary embodiment.

As shown in FIG. 2, the display device 100 according to the present exemplary embodiment is a device that performs analysis of a target system (referred to below as “system to be analyzed”) 200. The display device 100 is provided with a history information generation part 14 and an output part 18.

The history information generation part 14 generates history information of at least one of the respective sensors 21 and relationships among the sensors 21, based on a processing result of sensor values respectively outputted by the plurality of sensors 21 provided in the system 200 to be analyzed. It is to be noted that the number of sensors 21 provided in the system 200 to be analyzed is not limited to 4. The output part 18 presents, to a user, cluster information of each sensor 21 having one or more groups, based on causal relationship information among the sensors 21 and generated history information. Here, the cluster information includes identifiers indicating sensors 21 included in respective groups, and inter-group hierarchical structure information.

Sensor values outputted by respective sensors 21 are various types of value obtained from component elements of the system 200 to be analyzed. For example, as sensor values, measured values may be cited that are obtained through the sensors 21 provided in the component elements of the system 200 to be analyzed. As the measured values, for example, valve opening, liquid surface height, temperature, flow rate, pressure, electric current, voltage and the like may be cited. As sensor values, estimated values calculated using these measured values may be cited. In addition, as sensor values, control signals emitted by an information processing device in order to change the system 200 to be analyzed, to a desired operation state, may be cited.

As described above, in the present exemplary embodiment, groups of sensors 21 obtained from history information based on processing results of sensor values and hierarchical structure of the groups are presented. At this time, the plurality of sensors 21 are separated into groups according to events. Therefore, according to the present exemplary embodiment, in the system 200 to be analyzed, where a plurality of events occur, it is possible to separate the respective events and to output information corresponding to the respective events. Furthermore, by the groups being hierarchically structured, even where events caused in a chain, due to an event due to one basic cause, are obtained as a plurality of groups, it is possible to comprehend causal relationships thereof as a group hierarchical structure. Therefore, an operator can much more accurately comprehend the state of the system 200 to be analyzed.

Next, a further specific description is given concerning a configuration of the display device 100 according to the present exemplary embodiment, making reference to FIG. 3. FIG. 3 is a block diagram showing an example of a specific configuration of the display device 100 according to the present exemplary embodiment.

As shown in FIG. 3, the display device 100 of the present exemplary embodiment may be also provided with, in addition to the abovementioned history information generation part 14 and the output part 18, an analysis model acquisition part 12, an abnormality judging part 13, a clustering part 15, a cluster hierarchical structuring part 16, and a causal relationship acquisition part 17. A description is given later concerning these respective parts.

As shown in FIG. 3, the display device 100 is connected to the system 200 to be analyzed, via a network. The display device 100 analyzes abnormalities generated in the system 200 to be analyzed, from sensor values of the system 200 to be analyzed, and outputs an analysis result and additional information. It is to be noted that in FIG. 3, the broken line rectangle surrounding the history information generation part 14, the clustering part 15, the cluster hierarchical structuring part 16, and the output part 18 represents the fact that respective function blocks surrounded by the broken line operate based on information outputted by the abnormality judging part 13.

In the present exemplary embodiment, the system 200 to be analyzed includes at least one device 20 to be analyzed, and each device 20 to be analyzed is a target of analysis. As an example of the system 200 to be analyzed, a power generation plant system may be cited. In this case, as the device 20 to be analyzed, for example, a turbine, a feed water heater, a condenser and the like may be cited. The device 20 to be analyzed, for example, may include an element to connect between devices such as piping, signal lines or the like. In addition, the system 200 to be analyzed may be an overall system as in the abovementioned power plant system, or may be a portion for realizing some functionality in a certain system. In addition, it is possible to have assemblies or structures configured from elements that mutually affect each other, such as in an ICT (Information and Communication Technology) system, a chemical plant, a power plant, power equipment and the like.

For each of the devices 20 to be analyzed, a sensor 21 provided in each of the devices 20 to be analyzed measures a sensor value at prescribed timing, and transmits the measured sensor value to the display device 100. The sensor 21 in the present exemplary embodiment is not limited to concrete hardware as in a normal measurement apparatus. That is, the sensor 21 includes software, a control signal output source, or the like, and these are collectively referred to as a “sensor”.

The “sensor value” is a value obtained from the sensor 21. As examples of sensor values, measurement values may be cited that are measured by a measurement apparatus disposed in equipment, such as for valve opening, liquid surface height, temperature, flow rate, pressure, electric current, voltage and the like. As other examples of sensor values, an estimated value calculated from a measured value, a control signal value or the like may be cited. Below, each sensor value is expressed as a numerical value such as an integer or a decimal fraction. It is to be noted that in FIG. 3, one sensor 21 is provided for one device 20 to be analyzed. However, the number of sensors 21 provided for one device 20 to be analyzed does not have any particular limitation. In a case where an abnormality occurs in a sensor value, consideration may be given not only to a case where an abnormality occurs in a target measurement of sensor 21, but also a case where an abnormality (malfunction) occurs in the sensor 21 itself.

In the present exemplary embodiment, one data item is assigned to each sensor 21 corresponding to a sensor value obtained from the respective devices 20 to be analyzed. A set of sensor values collected at timing regarded as being the same, from the respective devices 20 to be analyzed, is denoted as “state information”. A set of data items corresponding to sensor values included in the state information is denoted as “data item group”.

That is, in the present exemplary embodiment the state information is composed of a plurality of data items. Here, “collected at timing regarded as being the same” may indicate being measured at the same time or a time within a prescribed range, by the respective devices 20 to be analyzed. In addition, “collected at timing regarded as being the same” may indicate being collected in a series of collection processes by the display device 100.

In the present exemplary embodiment, a storage device (not illustrated in FIG. 3) that stores sensor values obtained by the device 20 to be analyzed may be provided between the device 20 to be analyzed and the display device 100. As the storage device, for example, a data server, a DCS (Distributed Control System), SCADA (Supervisory Control And Data Acquisition), a process computer or the like may be cited. In a case of using this configuration, the device 20 to be analyzed obtains sensor values at arbitrary timing, and stores the obtained sensor values in the storage device. The display device 100 reads sensor values stored in the storage device at prescribed timing.

Here, a description is given concerning details of respective functional blocks of the display device 100. First, a state information collection part 11 collects state information from the system 200 to be analyzed. An analysis model acquisition part 12 obtains an analysis model of the system 200 to be analyzed. A causal relationship acquisition part 17 obtains causal relationship information among the sensors 21 (that is, information indicating causal relationships between sensor values outputted by the plurality of sensors 21).

The “analysis model” is a model used in determining whether the respective sensors 21 are either normal or abnormal in accordance with the respective sensor values of the plurality of sensors 21, and in calculating degree of abnormality indicating to what extent the respective sensors 21 are abnormal, and is built based on all or a portion of the plurality of data items forming the state information of the system 200 to be analyzed. When the state information collected by the state information collection part 11 is inputted, the analysis model performs a determination of whether each sensor 21 is normal or abnormal, and is used in order to perform calculation of the extent of abnormality.

The analysis model may be a set of a plurality of models. In a case of a set of a plurality of analysis models, the result of the determination of whether each sensor 21 is normal or abnormal may be duplicated. In addition, results of the determination of whether each sensor 21 is normal or abnormal duplicated in the analysis model need not be consistent. The analysis model may be built based on a time series of the state information obtained with regard to the system 200 to be analyzed.

Furthermore, in the present exemplary embodiment the analysis model may be contained in a storage device (not illustrated in FIG. 3) of the display device 100, or may be inputted from outside. In a case of the former, the analysis model acquisition part 12 obtains an analysis model from the storage device. On the other hand in a case of the latter, the analysis model acquisition part 12 obtains an analysis model from outside via an input device such as a keyboard or the like, or a network, a storage medium or the like.

The causal relationship information is information indicating causal relationships between the plurality of sensors 21; it is provided to all or a portion of the plurality of data items forming the state information of the system 200 to be analyzed; and it is used in order to give a hierarchical structure to groups. The causal relationship information may include identifiers that indicate the presence or absence of a causal relationship among the sensors 21. It is possible to use identifiers that enable the identification of 4 types of causal relationship. Specifically, it is possible to use an identifier (1 type) that indicates there is no causal relationship, an identifier (1 type) that indicates there is a causal relationship in both directions between 2 sensors 21, identifiers (2 types, reciprocally switching sensors 21 to correspond with cause and effect) indicating there is a causal relationship from one to another among 2 sensors 21.

The causal relationship information may be estimated from a time series of state information obtained by the state information collection part 11, or may be estimated from external information not depending on a time series of state information.

In a case of the former, the causal relationship acquisition part 17 uses general data analysis technology, for example, in order to estimate causal relationships among sensors 21 from a time series of state information obtained by the state information collection part 11. This method may be a method of estimating by calculating cross-correlation function while changing time difference of 2 time series data items, a method of using Transfer Entropy, a method of estimating a relationship between 2 sensors 21 by a regression equation and estimating while delaying time of coefficients of the regression equation, a method using Cross Mapping, or the like. With regard to the time series of the state information using the estimate of causal relationship, for example, user designation is possible when executing clustering, or a determination may be made based on a rule configured in advance. In a case of determining a time series of state information used in estimating causal relationships based on a rule configured in advance, for example, it is possible to do so from a point in time at which clustering is executed, to a point in time retracing a period determined in advance by an operator. This may also be from a point in time at which clustering is executed, until a time at which an abnormality judging part 13 judges an abnormality with regard to a prescribed number of sensors 21. Additionally, this may also be from a point in time at which clustering is executed, to a point in time retracting a further predetermined period from a time at which an abnormality judging part 13 judges an abnormality with regard to a prescribed number of sensors 21.

On the other hand in a case of the latter, the causal relationship acquisition part 17 may estimate causal relationships among sensors 21 from, for example, knowledge possessed by an expert, or an equation related to system operation.

In addition, in the present exemplary embodiment the causal relationship information may be contained in the storage device (not illustrated in FIG. 3) of the display device 100, or may be inputted from outside. In a case of the former, the causal relationship acquisition part 17 obtains causal relationship information from the storage device. On the other hand in a case of the latter, the causal relationship acquisition part 17 obtains causal relationship information from outside via an input device such as a keyboard, a network, a storage medium or the like.

The abnormality judging part 13, with regard to collected state information, performs a determination or calculation for at least one of the respective sensors 21 and relationships between the sensors 21, by applying the analysis model obtained by the analysis model acquisition part 12, and outputs a result thereof.

In the present exemplary embodiment, the history information generation part 14 generates history information from the result outputted by the abnormality judging part 13 in a prescribed period. The history information includes, for a prescribed period, time series data related to sensors 21 included in an analysis model or relationships being abnormal or normal among sensors 21 (that is, data outputted by respective sensors 21 being abnormal/normal, or relationships of sensor values outputted by different sensors 21 being abnormal/normal). Specifically, the history information includes identifiers of data items of the sensors 21 or of combinations of data items, and obtained normal or abnormal judgment results (time series data) according to the respective data items or combinations of data items. Here, identifiers of the data items or of combinations of the data items, of the sensors 21 included in the history information, may be duplicated, according to the analysis model.

The history information, for example, includes one or more of the following time series data (1) to (3).

### (1) “Time Series Data of Normal or Abnormal Judgment Result”

The history information, for example, includes data that holds information indicating normal or abnormal as a judgment result of the data, for each time associated with determined data, or for each time associated with state information belonging to the determined data. In a case of obtaining a plurality of normal or abnormal judgment results for one sensor 21, for example, these may be statistically processed to generate time series data of a normal or abnormal judgment result for one sensor 21. For example, this processing may include determining each time by majority decision, or setting a threshold for total value of judgment results of each time and forming a rule in advance concerning size relationship of threshold with total value and judgment result, to make a determination. Other processing may include, with sensors 21 as points, for a graph structure with a relationship between the sensors (for example, correlation model described later) as a line, calculating a normal or abnormal judgment result of a sensor 21 from a given graph pattern with normal or abnormal judgment result of relationships between the sensors 21 as information. A target of this processing calculation may be a judgment result at a certain time, or may be a judgment result with a particular period as target.

(2) “Time Series Data of Characteristic Amount Generated from Normal or Abnormal Judgment Result”

For example, the time series data of a characteristic amount includes information related to length of period in which normal or abnormal is generated continuously. The characteristic amount time series data, for example, may include the number of times normal or abnormal occurs continuously or non-continuously in a prescribed period. The characteristic amount time series data, for example, may include information related to the total of occurrence periods.

(3) “Time Series Data of Abnormality Degree Indicating Degree to which Sensor Value is Abnormal”

The time series data for abnormality degree of a sensor 21 includes a value estimating the degree to which the sensor 21 is abnormal. The time series data of abnormality degree of the sensor 21, for example, may include information related to divergence between actual measurement and estimated measurement of sensor value at a prescribed time (difference between actual measurement and estimated measurement, error ratio between actual measurement and estimated measurement). The time series data for abnormality degree of the sensor 21, for example, may include contribution to Q statistic or T² statistic in multivariate statistical process management.

In the present exemplary embodiment, the history information generation part 14 may obtain information necessary for generating history information from not only the abnormality judging part 13 described above, but also the analysis model acquisition part 12.

The clustering part 15 performs clustering of each of the plurality of sensors 21 into one or more groups, based on the generated history information. The clustering part 15, for example, performs clustering of the sensors 21 included in an analysis model into one or more groups, based on the time series data in the abovementioned prescribed period.

The clustering part 15 first assigns data items or combinations of data items to group members according to a clustering algorithm. As a group member, in a case including a combination of data items (equivalent to relationships between the sensors 21), the clustering part 15 applies statistical processing to the combination of data items, and estimates data items related to an abnormality, and the group members are formed of data items only.

The clustering part 15 may use a clustering algorithm used in data mining such as Ising model clustering, k-means, x-means, NMF (Non-negative Matrix Factorization), Convolutive-NMF, affinity propagation or the like, to perform clustering of data items or combinations of data items.

The time series data in the abovementioned prescribed period, included in the history information, may have a one dimensional characteristic amount at each time (a scalar value, for example, duration of abnormality) defined. In this case, the clustering part 15, in addition to a clustering algorithm used in the abovementioned data mining, may also use an algorithm for time series segmentation or change point detection used by data mining. It is to be noted that in other examples, the characteristic amount included in the history information is not limited to one dimension.

The clustering part 15 may use clustering results sequentially to execute clustering multiple times.

In order to estimate data items related to abnormalities, a graph pattern mining method, for example, may be used as statistical processing executed on combinations of data items. Specifically, with sensors 21 as points, for a graph structure with a relationship between the sensors 21 (for example, correlation model described later) as a line, calculation may be performed for a normal or abnormal judgment result of a sensor 21, from a given graph pattern with normal or abnormal judgment result of relationships between the sensors 21 as information.

The clustering part 15 estimates abnormality starting time for each group as cluster information. When data items and combinations of data items are clustered, the abnormality starting time for each group is estimated from history information thereof assigned to respective groups. For example, a time at which one among the data items or combination of data items included in respective groups is first determined to be abnormal is taken as the starting time of an abnormality. In another example, a time at which one among the data items or combination of data items included in respective groups is determined to be continuously abnormal is taken as the starting time of an abnormality.

The cluster hierarchical structuring part 16 gives a hierarchical structure to groups generated by the clustering part 15, based on causal relationship information among the sensors 21 obtained by the causal relationship acquisition part 17, and abnormality starting time for each group.

The cluster hierarchical structuring part 16, in a case of estimating that there is a causal relationship among the groups, gives a hierarchical structure based on direction of cause-effect among groups thereof. On the other hand the cluster hierarchical structuring part 16 does not give a hierarchical structure to groups where a causal relationship is not recognized with respect to any group.

The cluster hierarchical structuring part 16 estimates direction of cause-effect among groups based on abnormality starting time for respective groups. Specifically the cluster hierarchical structuring part 16 takes the direction from a group with early abnormality starting time towards a group with abnormality starting time being slow, as direction of cause-effect.

The cluster hierarchical structuring part 16 adds up the number of causal relationships in the estimated cause-effect direction, among 2 groups for all or a portion thereof, and determines causal relationship among the groups, based on the total value thereof. The cluster hierarchical structuring part 16 may use, as a determination condition, a condition of the total value being greater than or equal to a number set in advance. The cluster hierarchical structuring part 16 may use, as a determination condition, a condition that a value of the total value divided by the number of combinations among members of 2 groups is greater than or equal to a number set in advance.

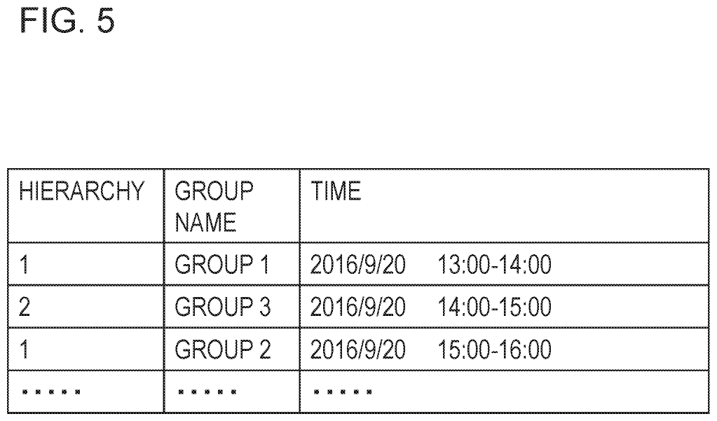

The output part 18, as shown in FIG. 4 for example, presents to a user (for example, an operator) or a system, groups of sensors 21 obtained by clustering by the clustering part 15, and a hierarchical structure obtained by a calculation by the cluster hierarchical structuring part 16. The output part 18, as shown in FIG. 5 for example, may further output a result of estimating the range of time in which the occurrence of an abnormality is suspected for each group of the sensors 21. It is to be noted that FIG. 4 and FIG. 5 respectively indicate only an example of an output result by the display device 100 in the present exemplary embodiment, and the output result is not limited to modes shown in the figures.

Additionally, in the present exemplary embodiment the output part 18, in addition to groups, may output degree of abnormality, a statistical value thereof, or a recalculated value thereof, for a prescribed time for a sensor 21 belonging to a group in focus. It is to be noted that the method of presenting groups of sensors 21 by the output part 18 is not limited to these methods.

The output part 18 may present groups of sensors 21 in sensor name list form. Additionally, as shown in FIG. 6, the output part 18 may present a hierarchical structure and set of groups linked by a hierarchical structure as identifiable markers (identifiers) in a system configuration diagram. In a case of the latter, that is, in a case where for a groups of sensors 21, a hierarchical structure and set of groups linked by a hierarchical structure are presented as identifiable markers in a system configuration diagram, the output part 18 may indicate a time sequence in which an abnormality occurrence is suspected for a portion corresponding to a hierarchical structure of a marker. The output part 18 may configure a marker(s) to enable distinguishing a group that does not have a hierarchical structure and a group that has a hierarchical structure.

FIG. 6 is a diagram showing an example of an output result by the display device 100 according to the present exemplary embodiment. It is to be noted that the system to be analyzed, shown in FIG. 6, is a power generation plant system. In FIG. 6, the number immediately following G in G1-1, G1-2 and G2 is a number given to a hierarchically structured group set. Meanwhile, the number following the hyphens is a number given to a layer within a group set. Whether or not there is a hyphen in a label indicates whether or not there is a hierarchical structure. It is to be noted that the output part 18 is not limited to a character string as a method of representing whether or not there is a hierarchical structure, and may use another representation method such as color, shape, or the like. FIG. 6 has a configuration of markers that enable identification of groups and hierarchical structure, by labels combining these 2 types of numbers. It is to be noted that the output part 18 is not limited to a character string as a representation method used to enable identification of a hierarchical structure and set of groups linked by a hierarchical structure, and may use another representation method such as color, shape, or the like. A method of individually representing a group set or hierarchical structure also is not limited to the modes illustrated in the drawings. Additionally, the number of layers is not limited to 2, and it is also possible to have a multilayered structure.

The output part 18 may provide a presentation emphasizing only a portion of a hierarchical structure and set of groups linked by a hierarchical structure.

Additionally, the output part 18 may present only a portion of a hierarchical structure and set of groups linked by a hierarchical structure.

The output part 18 may present a set of groups linked by a hierarchical structure, switching groups displayed in accordance with sequence of time in which an abnormality occurrence is suspected. At this time, the output part 18 may switch an emphasized group set instead of completely switching the display. The output part 18 may automatically perform the switching at prescribed time intervals. The output part 18 may repeat a series of displays including this switching a prescribed number of times, or until there is a user operation.

The output part 18 may display some group(s) of a set of groups linked by a hierarchical structure. At this time, the output part 18 may switch an emphasized group set or groups, instead of completely switching the display.

The output part 18 may present a set of groups linked by a hierarchical structure, switching groups displayed in accordance with sequence of time in which an abnormality occurrence is suspected. At this time, the output part 18 may switch an emphasized group set instead of completely switching the display. The output part 18 may execute the switching in accordance with a user operation, or may automatically perform the switching at prescribed time intervals. The output part 18 may repeat a series of displays including this switching a prescribed number of times, or until there is a user operation.

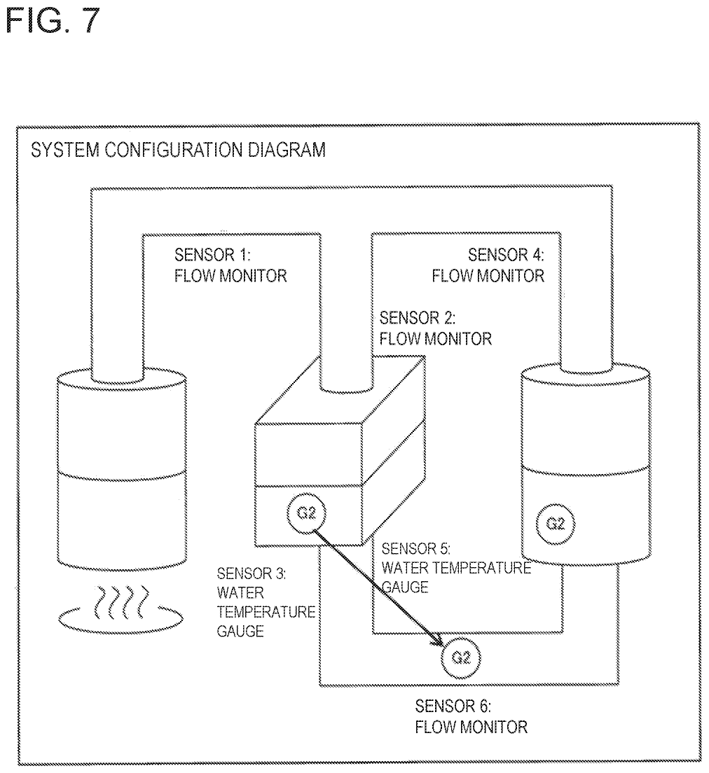

The output part 18 may present at least one of causal relationship information within a group, and causal relationship information between groups. The output part 18, when switching and displaying both, may execute the switching in accordance with a user operation, or may automatically perform the switching at prescribed time intervals. The output part 18 may repeat a series of displays including this switching a prescribed number of times, or until there is a user operation. The output part 18 may present causal relationship information within a group and causal relationship information between groups, using different representation methods. For example, the output part 18 may represent causal relationship information among groups by labels assigned to the groups, while it may represent causal relationship information within a group as an arrow from a sensor 21 that is a cause to a sensor that is a result, as shown in FIG. 7.

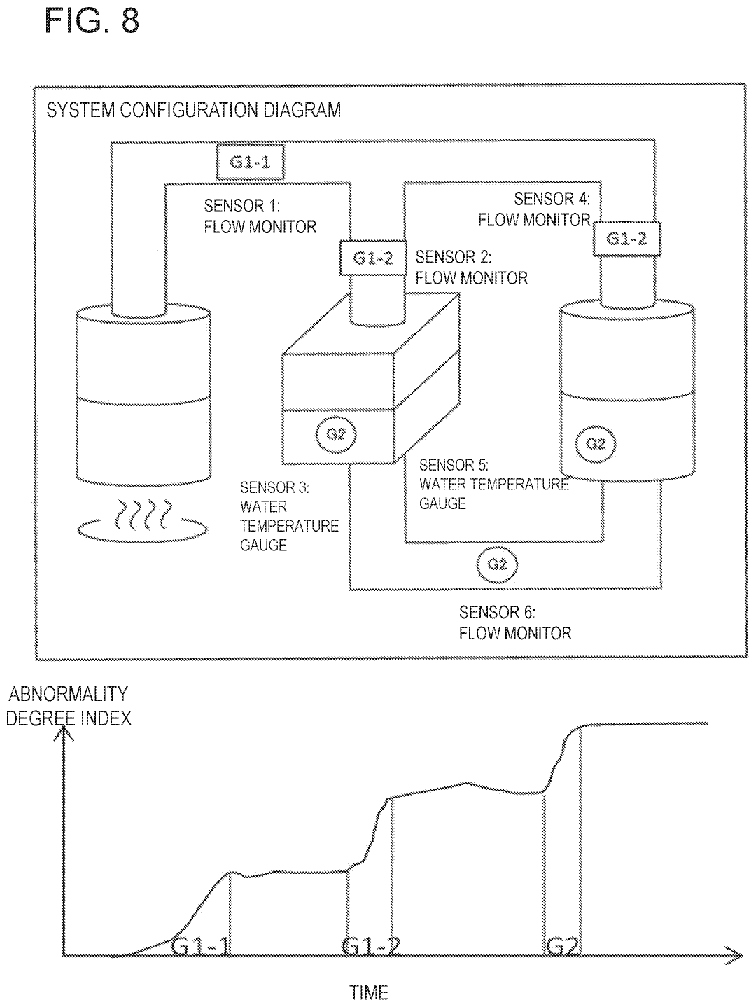

The output part 18, as shown in FIG. 8, may give a symbol(s) to respective groups in a time corresponding to the abnormality start time of respective groups, to output time series data of an abnormality degree index (indicating degree of abnormality) related to a system or device. Since it is possible to comprehend the abnormality degree and transitions of abnormality state collectively, by outputting in this way, a user can effectively comprehend the state of the system 200 to be analyzed.

The output part 18 may present a proportion according to type of physical quantity of sensors 21 included in a group or a group set of the sensors 21, and the proportion of a sensor 21 “line” included a group of the sensors 21, as a pie chart or a list. It is to be noted that a “line” indicates a configuration unit of a functional system. The “line” may be specified in advance by an operator.

### <Operation>

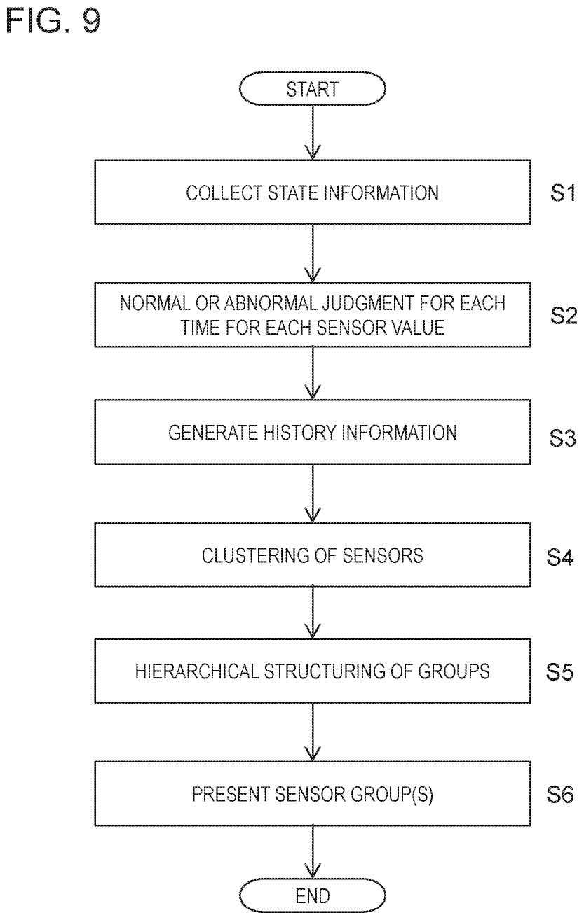

Next, a description is given concerning operation of the display device 100 in the present exemplary embodiment, making reference to FIG. 9. FIG. 9 is a flow chart showing an example of operations of the display device 100 according to the present exemplary embodiment. In the following description, FIG. 2 and FIG. 3 are referred to as appropriate. In the present exemplary embodiment, a display method is implemented by making the display device 100 operate. Therefore, the display method according to the present exemplary embodiment is described according to operations of the display device 100 as follows.

Here, as an example, the analysis model acquisition part 12 obtains an analysis model in advance. The causal relationship acquisition part 17 obtains information of causal relationships among the sensors 21 in advance.

As shown in FIG. 9, the state information collection part 11 collects state information in a prescribed period from the system 200 to be analyzed (step S1).

Next, the abnormality judging part 13 uses the analysis model obtained in advance by the analysis model acquisition part 12 to judge sensor values included in state information for each time (step S2). As an example, the abnormality judging part 13 judges for each time whether sensors 21 or relationships between sensors 21 belong to a normal or an abnormal state. As another example, the abnormality judging part 13 judges, for each time, abnormality degree of sensors 21 or relationships between sensors 21.

Next, the history information generation part 14 generates history information from a judgment result of sensors 21 or relationship between sensors 21 by the abnormality judging part 13 (step S3). Specifically the history information generation part 14 obtains a normal or abnormal judgment result of the sensors 21 or relationships between the sensors 21 by the abnormality judging part 13 according to a time series, and the judgment result obtained according to the time series (that is, time series data) is taken as history information.

Next, the clustering part 15 performs clustering of the sensors 21 included in the analysis model into one or more groups, based on the generated history information generated in step S3 (step S4). Specifically, the clustering part 15 uses the abovementioned clustering method, based on abnormal or normal related time series data for respective sensors 21 in a prescribed period, included in the history information, and performs clustering of the respective sensors 21.

Next, the cluster hierarchical structuring part 16 hierarchically structures groups generated in step S4, based on causal relationship information among the sensors 21 obtained from the causal relationship acquisition part 17 (step S5).

Next, the output part 18 presents the groups of sensors 21 obtained by clustering according to step S4 and the hierarchical structure thereof obtained in step S5 to a user (for example, an operator), to the system, or the like (step S6).

According to the above, processing with regard to the display device 100 is completed. After a prescribed period has elapsed, when state information is outputted from the system 200 to be analyzed, the display device 100 executes steps S1 to S6 again.

### <Effect>

As described above, in the present exemplary embodiment, even in a case including a plurality of events, the display device 100 can separate events by clustering. Thus, with the display device 100 it is possible to output information for each event. Furthermore, by the groups being hierarchically structured, even where events caused in a chain, due to an event due to one basic cause, are obtained as a plurality of groups, since it is possible to comprehend the causal relationship thereof as a group hierarchical structure, the operator can more precisely comprehend the state of the system 200 to be analyzed.

That is, in the present exemplary embodiment, since the sensors 21 are clustered based on abnormal or normal related time series data of all sensors 21 included in an analysis model, the sensors 21 are clustered for each abnormal or normal related time series change. Therefore, even in a case where a plurality of types of abnormality occur consecutively, and the time of occurrence is different for each abnormality type, the state is such that the respective sensors 21 are separated according to abnormality type. As a result, the user can obtain information for each abnormality type. According to the present exemplary embodiment, even where events caused in a chain, due to an event due to one basic cause, are obtained as a plurality of groups, it is possible to comprehend causal relationships thereof as a group hierarchical structure. Therefore, the operator can more precisely comprehend the state of the system 200 to be analyzed.

Continuing, a description is given below concerning a modified example of the present exemplary embodiment. It is to be noted that in the following, the description is centered on points of difference from the first exemplary embodiment described above.

### Modified Example 1

In modified example 1, the history information generation part 14 identifies the length of time for which an abnormality is judged for respective sensors 21, for each sensor 21, and takes the identified time length as history information. In the modified example 1, the history information includes a data item identifier for a sensor 21, and the length of time for which an abnormality is judged for a sensor 21. The history information generation part 14 may obtain the proportion, of a prescribed period, in which the respective sensors 21 are judged to be abnormal, and may identify the length of time for which an abnormality is judged for a sensor 21, by multiplying the obtained proportion by the prescribed period. As another method, the history information generation part 14 may identify the length of time for which an abnormality is judged for a sensor 21, by adding up the periods for which an abnormality is judged for the respective sensors 21 in a prescribed period. As a further method, the history information generation part 14 may identify the length of time for which an abnormality is judged for a sensor 21, by adding up the number of times the respective sensors are judged to be abnormal in a prescribed period, or the number of times there is a transition from normal to abnormal.

Here, the length of time for which an abnormality is judged for respective sensors 21 is also abnormal or normal related time series information. Therefore, in a case of using the modified example 1, a result similar to the abovementioned first exemplary embodiment is obtained. Additionally, since the length of time for which an abnormality is judged for a sensor 21 is one dimensional data, according to modified example 1 the clustering part 15 can execute calculation of clustering with fewer computational resources than the first exemplary embodiment described above.

### Modified Example 2

In modified example 2, the history information generation part 14 respective sensors 21 identifies the length of time for which an abnormality is judged for respective sensors 21, and, for each sensor 21, takes the identified time length as history information. In modified example 2, the history information includes an identifier of a sensor 21 data item or a combination of data items, and, for a prescribed period, the length of time for which an abnormality is continuously judged for a sensor 21 (referred to below as “continuous abnormality time”) with the latest time as an end point.

The history information generation part 14 may also use statistical processing to calculate the length of continuous abnormality time. This is because there may be a case where sensor data is unstable due to sensor noise or disturbance, or a case of the abnormality degree being low and the normal or abnormal judgment wavering between normal and abnormal.

Specifically, the history information generation part 14 first divides a prescribed period into a plurality of periods, and judges whether or not the proportion of times for which an abnormality is judged is larger than a prescribed threshold, for each divided period. The history information generation part 14 identifies a plurality of divided period groups for which a judgment result is continuously abnormal, with the latest time of the prescribed period as end point, and takes the length of the identified divided period groups as the length of continuous abnormality time. It is to be noted that for the prescribed period, for each sensor 21, duplication of normal or abnormal judgment results for each relationship between the sensors 21 may be permitted or may not be permitted.

A prescribed threshold used in judgment of a divided period may be set by giving an arbitrary numerical value by the user. A prescribed threshold may be set based on a Poisson distribution confidence interval for length of divided period when normal or abnormal instability is assumed to be random.

The history information generation part 14 may ignore a normal period (that is, regard as abnormal) in a case of an abnormality occurring again after being temporarily normal in an interval shorter than a prescribed length. In the method in question, there is a case where it is possible to calculate valid continuous abnormality time.

The continuous abnormality time also is abnormal or normal related time series data. Therefore, in a case of using the modified example 2, a result similar to the abovementioned first exemplary embodiment is obtained. Additionally, since the continuous abnormality time is one dimensional data, according to modified example 2, similar to modified example 1, the clustering part 15 can execute calculation of clustering with fewer computational resources. In modified example 2, since the sensors 21 are clustered based on continuous abnormality time, clustering is performed with instability regarding normal or abnormal judging being taken into account. Therefore, according to modified example 2, it is possible to present a more accurate group of sensors 21.

### Modified Example 3

In the modified example 3, the target of calculation for history information is limited to only a relationship between 2 sensors 21. That is, data item combinations are limited to a combination of two sensors 21. This is equivalent to a special case of the first exemplary embodiment. Therefore, in modified example 3, the analysis model obtained by the analysis model acquisition part 12 is different from the first exemplary embodiment described above.

In modified example 3, the analysis model acquisition part 12 obtains a set of one or more correlation models, as an analysis model. The correlation model is configured such that when a sensor value of one or more prescribed sensors 21 is inputted, it is possible to estimate a prescribed sensor value. The correlation model includes a regression equation that estimates a particular sensor value using one or more sensor values outside the data items, and tolerance range for estimated error.

The abnormality judging part 13 makes a normal or abnormal judgment for each sensor 21, that is, for each correlation model, by applying the correlation model to collected state information, and outputs a judgment result thereof.

In modified example 3, the history information generation part 14 identifies the length of time for which the correlation model continuously outputs that there is an abnormality, and creates the identified time length as history information. The history information includes the length of time for which the correlation model is continuously judged as abnormal, with the latest time of the prescribed period as an end point. Specifically, the history information includes a correlation model identifier, data items included in the correlation model, and length of time for which the correlation model continuously makes a judgment of abnormal, with the latest time of the prescribed period as an end point (referred to below as “correlation model abnormal continuous time”).

The history information generation part 14 may use statistical processing to calculate the length of the correlation model abnormal continuous time. This is because there may be a case where sensor data is unstable due to sensor noise or disturbance, or a case of the abnormality degree being low and the normal or abnormal judgment wavering between normal and abnormal. The history information generation part 14 may obtain information necessary for generating history information from the analysis model acquisition part 12 and the abnormality judging part 13.

Specifically, the history information generation part 14 first divides a prescribed period into a plurality of periods, and judges whether or not the proportion of times for which an abnormality is judged is larger than a prescribed threshold, for each divided period. The history information generation part 14 identifies a plurality of divided period groups for which a judgment result is continuously abnormal, with the latest time of the prescribed period as end point, and takes the length of the identified divided period groups as the length of correlation model continuous abnormality time. It is to be noted that for the prescribed period, for each sensor 21, duplication of normal or abnormal judgment results may be permitted or may not be permitted.

A prescribed threshold used in a judgment with regard to divided periods may be set by the user giving an arbitrary numerical value, or may be set based on a Poisson distribution confidence interval for length of divided period when normal or abnormal instability is assumed to be random.

In modified example 3, the clustering part 15 performs clustering of one or more groups of sensors 21, based on abnormal or normal related time series data of all correlation modes included in the analysis model, for the prescribed period.

Specifically, the clustering part 15 first performs clustering of each correlation model included in the analysis model, into one or more groups, based on abnormal or normal related time series data of all correlation models included in the analysis model, in the prescribed period. Continuing, the clustering part 15 performs clustering of respective sensors 21 based on a result of clustering of correlation models.

The clustering part 15, for example, counts, for each sensor 21, the number of appearances included in the correlation model for each group, and assigns respective sensors 21 to a group with the largest number of appearances thereof. At this time, if there are groups with the same value for number of times, the sensor 21 may be assigned in duplicate to each of the groups with the same value, or may be assigned to any one group based on a prescribed rule.

In modified example 3, the clustering part 15 may use a clustering algorithm used in data mining such as Ising model clustering, k-means, x-means, NMF (Non-negative Matrix Factorization), Convolutive-NMF, affinity propagation or the like, to perform clustering of a correlation model.

For example, in a prescribed period, abnormal or normal related time series data of all correlation models may have a one dimensional characteristic amount with regard to time (for example, continuous time of abnormality or the like). In this case, the clustering part 15, in addition to a clustering algorithm used in data mining, may also use an algorithm for time series segmentation or change point detection used by data mining.

### Modified Example 4

In modified example 4, the cluster hierarchical structuring part 16 carries out hierarchical structuring only for groups in which group abnormality start time is closest. With this type of configuration, since group hierarchical structure does not accompany branching, it is possible to inhibit complexity of output results.

### <Program>

A program according to the present exemplary embodiment executes steps S1 to S6 shown in FIG. 9, on a computer. By installing and executing the program in question on a computer, it is possible to implement the display device 100 and the display method in the present exemplary embodiment. In this case, the computer CPU (Central Processing Unit) performs processing while functioning as a state information collection part 11, an analysis model acquisition part 12, an abnormality judging part 13, a history information generation part 14, a clustering part 15, a cluster hierarchical structuring part 16, a causal relationship acquisition part 17 and an output part 18.

The program in the present exemplary embodiment may be executed by a computer system configured by a plurality of computers. In this case, for example, the computer CPU (Central Processing Unit) may function as any of a state information collection part 11, an analysis model acquisition part 12, an abnormality judging part 13, a history information generation part 14, a clustering part 15, a cluster hierarchical structuring part 16, a causal relationship acquisition part 17 and an output part 18.

The program in the present exemplary embodiment is contained in a storage device of the computer implementing the display device 100, and is executed by being read by the CPU of the computer. In this case, the program may be provided as a computer readable storage medium, or may be provided via a network.

### Second Exemplary Embodiment

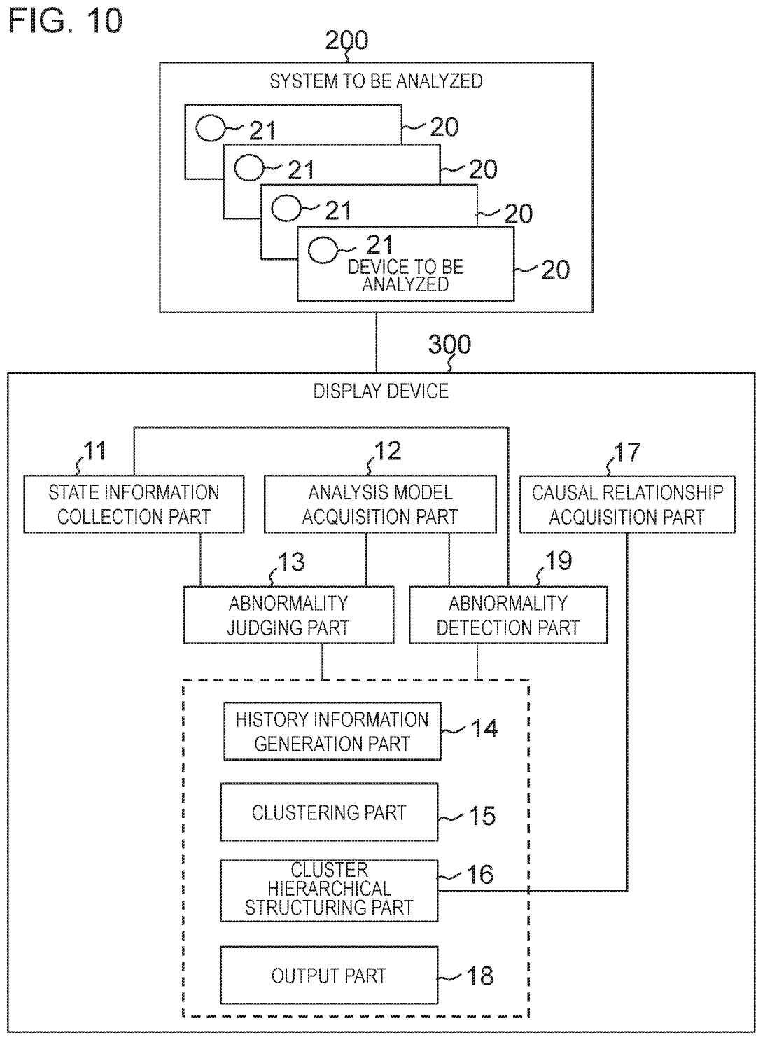

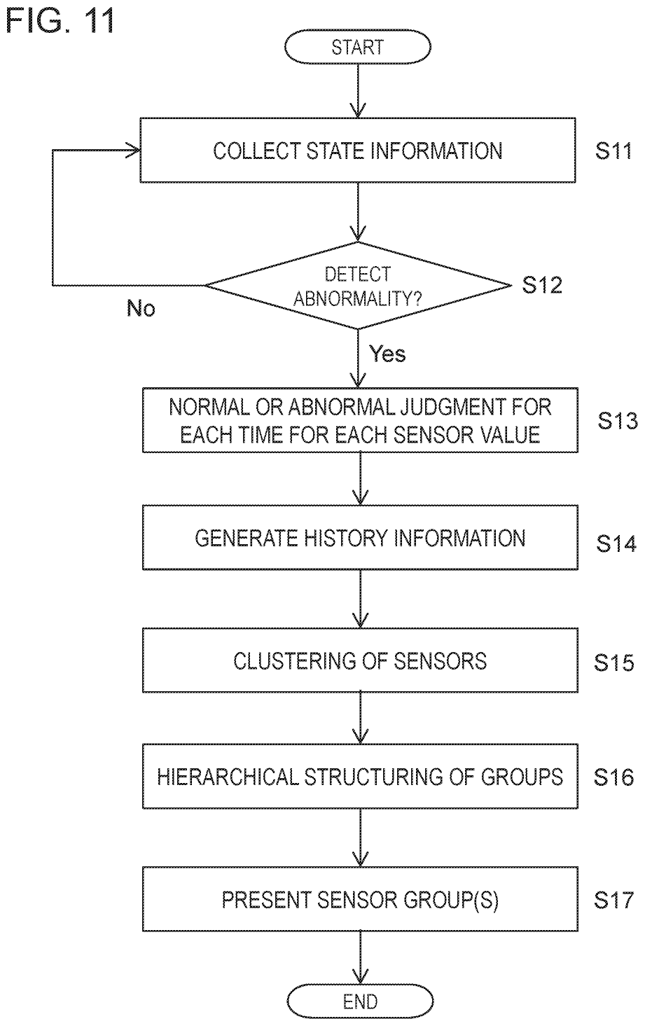

Next, a description is given concerning a display device, a display method, and a program according to a second exemplary embodiment, making reference to FIG. 10 and FIG. 11.

### <Configuration>

First, a description is given concerning a configuration of the display device in the second exemplary embodiment making reference to FIG. 10. FIG. 10 is a block diagram showing an example of a specific configuration of the display device 300 according to the present exemplary embodiment.

As shown in FIG. 10, the display device 300 in the present exemplary embodiment differs from the display device 100 in the first exemplary embodiment shown in FIG. 2 and FIG. 3, and is provided with an abnormality detection part 19. With regard to points outside of this, the display device 300 has a configuration similar to the display device 100. Therefore, the description below is centered on points of difference between the present exemplary embodiment and the first exemplary embodiment.

The abnormality detection part 19 detects an abnormality of a system 200 to be analyzed, a device 20 to be analyzed, or a sensor 21, based on state information collected by the state information collection part 11. Specifically, the abnormality detection part 19 compares a sensor value included in state information with a prescribed abnormality detection condition, and in a case where the sensor value satisfies an abnormality detection condition, detects an abnormality.

In the present exemplary embodiment, the abnormality detection condition uses a sensor value of a particular sensor 21, and increase/decrease range of sensor value, or the like, and furthermore is set by a combination thereof. The abnormality detection condition may be an abnormality detection condition set in an analysis model.

In the present exemplary embodiment, the history information generation part 14 generates history information based on the point in time at which an abnormality is detected by the abnormality detection part 19. For example, a target period for generation of history information may be a past prescribed period with a point in time at which an abnormality is detected as reference. The length of the prescribed period may be arbitrarily specified by the user. The start point of the prescribed period may be the oldest time in a period in which an abnormality occurs, as analyzed using the analysis model, or may be a point in time at which the clustering immediately before is executed. The end point of the prescribed period may be a point in time before or after, according to prescribed adjustment, such as a point in time for which the point in time at which an abnormality is detected is shortened by a prescribed period, or a point in time lengthened by a prescribed period.

A causal relationship acquisition part 17 may estimate causal relationship information from a time series of state information obtained by the state information collection part 11, or may obtain causal relationship information from external information that does not detect on a state information time series.

In a case of the former, the causal relationship acquisition part 17 may use general data analysis technology, for example, in order to estimate a causal relationship among sensors 21 from a time series of state information obtained by the state information collection part 11.

This method may be a method of estimating by calculating cross-correlation function while changing time difference of 2 time series data items, a method of using Transfer Entropy, a method of estimating a relationship between 2 sensors 21 by a regression equation and estimating while delaying time coefficients of the regression equation, a method using Cross Mapping, or the like. With regard to the time series of the state information used in the estimate of causal relationship, for example, user designation is possible when executing clustering, or a determination may be made based on a rule configured in advance. In a case of determining time series of state information used in estimating a causal relationship based on the rule configured in advance, for example, it is possible to do so from a point in time at which clustering is executed, to a point in time retracing a period determined in advance by an operator. This may also be from a point in time at which clustering is executed, to a time at which an abnormality judging part 13 judges an abnormality with regard to a prescribed number of sensors 21. Additionally, this may also be from a point in time at which clustering is executed, to a point in time retracting a further predetermined period from a time at which the abnormality judging part 13 judges an abnormality with regard to a prescribed number of sensors 21. A period is also possible that is set based on a predetermined rule, with the time at which the abnormality detection part 19 detects an abnormality as reference.

On the other hand in a case of the latter, the causal relationship acquisition part 17 may estimate a causal relationship among sensors 21 from, for example, knowledge possessed by an expert, or an equation related to system operation.

### <Operation>

Next, a description is given concerning operation of the display device 300 in the present exemplary embodiment, making reference to FIG. 11. FIG. 11 is a flow chart showing an example of operations of the display device 300 according to the present exemplary embodiment. In the following description, FIG. 10 is referred to as appropriate. In the present exemplary embodiment, a display method is implemented by operating the display device 300. Therefore, the display method according to the present exemplary embodiment is described according to operations of the display device 300 as follows.

Here, it is assumed that the analysis model acquisition part 12 obtains an analysis model in advance.

As shown in FIG. 11, the state information collection part 11 collects state information in a prescribed period from the system 200 to be analyzed (step S11).

Next, the abnormality detection part 19 executes abnormality detection based on state information collected in step S11, and judges whether or not an abnormality has been detected (step S12). As a result of the judgment, in a case where an abnormality is not detected (No in step S12), step S11 is again executed after a prescribed period has elapsed.

On the other hand in a case where an abnormality is detected (Yes in step S12), the abnormality judging part 13 applies state information to the analysis model obtained in advance by the analysis model acquisition part 12, and makes a normal or abnormal judgment for each time (step S13).

Next the history information generation part 14 generates history information from a normal or abnormal judgment result of sensors 21 or relationship between sensors 21 by the abnormality judging part 13, based on a past prescribed period with a point in time at which an abnormality is detected according to step S12 as reference (step S14).

Next, the clustering part 15 performs clustering of the sensors 21 included in the analysis model into one or more groups, based on the history information generated in step S14 (step S15).

Next, the cluster hierarchical structuring part 16 hierarchically structures groups generated in step S15, based on causal relationship information among the sensors 21 obtained from the causal relationship acquisition part 17 (step S16).

Next, the output part 18 presents the groups of sensors 21 obtained by clustering according to step S15 and the hierarchical structure of the groups obtained in step S16 to a user (for example, an operator) or the system (step S17).

With the above, processing in the display device 130 is completed. After a prescribed period has elapsed, when state information is outputted from the system 200 to be analyzed, the display device 300 executes steps S11 to S17 in FIG. 11 again.

### <Effect>

As described above, according to the display device 300 in the present exemplary embodiment, it is possible to obtain an effect similar to the display device 100 of the first exemplary embodiment. In addition, in the present exemplary embodiment, in order to perform abnormality detection, a period in which history information is generated is automatically set. Therefore, according to the present exemplary embodiment the operator can greatly reduce the load in system operation.

### <Program>

A program according to the present exemplary embodiment executes steps S11 to S17 shown in FIG. 11, on a computer. By installing and executing the program in question on a computer, it is possible to implement the display device 300 and the display method in the present exemplary embodiment. In this case, the computer CPU (Central Processing Unit) performs processing while functioning as a state information collection part 11, an analysis model acquisition part 12, an abnormality judging part 13, a history information generation part 14, a clustering part 15, a cluster hierarchical structuring part 16, a causal relationship acquisition part 17, an output part 18, and an abnormality detection part 19.

The program in the present exemplary embodiment may be executed by a computer system configured by a plurality of computers. In this case, for example, respective computers may function as any of the state information collection part 11, the analysis model acquisition part 12, the abnormality judging part 13, the history information generation part 14, the clustering part 15, the cluster hierarchical structuring part 16, the causal relationship acquisition part 17, the output part 18, and the abnormality detection part 19.

The program in the present exemplary embodiment may be contained in a storage device of the computer implementing the display device 300, and may be executed by being read by the CPU of the computer. In this case, the program may be provided as a computer readable storage medium, or may be provided via a network.

However, in the abovementioned first and second exemplary embodiments, a description was given of a case where the system 200 to be analyzed is a power generation plant system, but in the present invention, the system 200 to be analyzed is not limited thereto. For the system 200 to be analyzed, an IT (Information Technology), a plant system, a structure, a transport aircraft or the like may be cited. In such cases also, for the display device 100 (or 300), with types of data included in information indicating state of the system to be analysis as data items, the data items can be clustered.

In the abovementioned first and second exemplary embodiments, a description was given centered on an example in which respective functional blocks of the display device 100 (or 300) are implemented by a CPU executing a computer program stored on a storage device or ROM (Read Only Memory). However the present invention is not limited thereto. In the present invention, the display device 100 (or 300) all the respective functional blocks may be implemented by dedicated hardware, or some of the function blocks may be implemented by hardware and the remainder may be implemented by software.

In the present invention, the abovementioned first and second exemplary embodiments may be implemented as a suitable combination. The present invention is not limited to the respective exemplary embodiments described above, and may be implemented in various modes.

### (Physical Configuration)

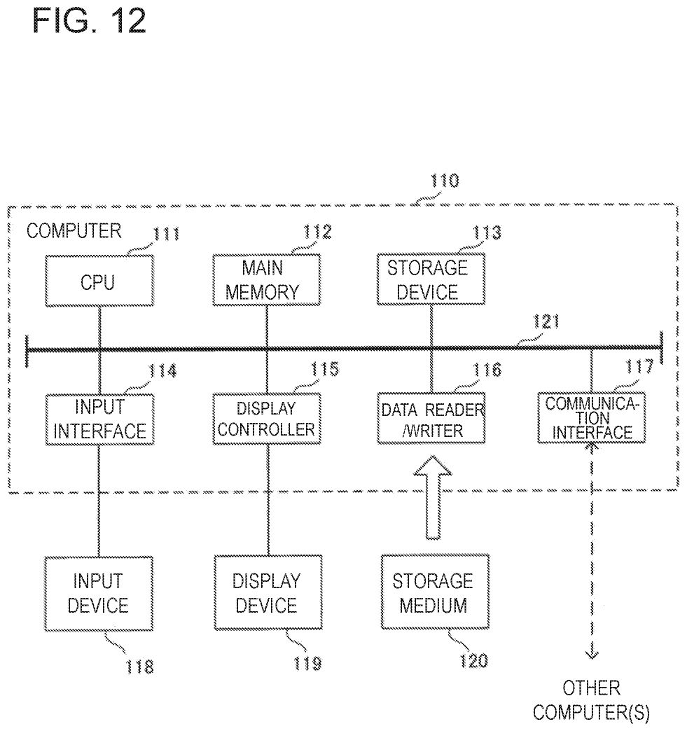

Here, a description is given concerning a computer that realizes the display device by executing the program in the first and second exemplary embodiment, making reference to FIG. 12. FIG. 12 is a block diagram showing an example of a computer that realizes the display device 100, 300 according to the first and second exemplary embodiments.

Referring to FIG. 12, the computer 110 is provided with a CPU (Central Processing Unit) 111, a main memory 112, a storage device 113, an input interface 114, a display controller 115, a data reader/writer 116, and a communication interface 117. These respective parts are inter-connected via a bus 121 to enable data communication.

The CPU 111 deploys the program (code) of the first or second exemplary embodiment, contained in the storage device 113, to main memory, and by execution thereof in a prescribed sequence, performs various types of operation. The main memory 112 is typically volatile storage device such as DRAM (Dynamic Random Access Memory) or the like. The program in the first or second exemplary embodiment is provided in a state contained in a computer readable storage medium 120. It is to be noted that the program in the present exemplary embodiment may be distributed on the Internet connected via the communication interface 117.

As a specific example of the storage device 113, in addition to a Hard Disk Drive (HDD), a semiconductor storage device such as flash memory may be cited. The input interface 114 is an intermediary for data transmission between the CPU 111 and an input device 118 such as a keyboard or a mouse. The display controller 115 is connected to the display device 119 and controls the display by the display device 119.

The data reader/writer 116 is an intermediary for data transmission between the CPU 111 and the storage medium 120, reads a program from the storage medium 120, and executes writing to the storage medium 120 of a processing result of the computer 110. The communication interface 117 is an intermediary for data transmission between the CPU 111 and another computer.

As a specific example of the storage medium 120, a generic semiconductor storage device such as a CF (Compact Flash (registered trademark)), SD (Secure Digital) or the like, a magnetic storage medium such a Flexible Disk or the like, or an optical storage medium such as a CD-ROM (Compact Disk Read Only Memory) or the like may be cited.

As described above, according to the abovementioned exemplary embodiment, where abnormalities of plural types occur in a system to be analyzed, the invention enables the abnormalities to be separated according to type and information to be outputted for each type. The present invention, as an example, may be preferably applied to use for abnormality diagnosis in a system.

It is to be noted that the following modes are possible in the present invention.

### <First Mode>

As in the display method according to the first aspect described above.

### <Second Mode>

The display method according to the first mode, wherein a hierarchy among the plurality of groups is determined based on causal relationships among abnormal sensors belonging to the plurality of groups.

### <Third Mode>

The display method according to the second mode, wherein a causal relationship among the plurality of groups is determined based on causal relationships among abnormal sensors belonging to the plurality of groups.

### <Fourth Mode>

The display method according to any one of the first to third modes wherein the symbol can distinguish before/after abnormality starting time estimated with a group to which an abnormal sensor corresponding to the symbol belongs.

### <Fifth Mode>

The display method according to any one of the first to fourth modes wherein, in a step of presenting to the user, information indicating range of abnormality time estimated with respective groups is further presented to the user.

### <Sixth Mode>

The display method according to any one of the first to fifth modes wherein, in a step of presenting to the user, the symbols are presented to the user being superimposed on a diagram showing the target.

### <Seventh Mode>

The display method according to any one of the first to sixth modes, including a step of indicating at least one of: information indicating hierarchical relationships of the plurality of groups, and information indicating causal relationships among abnormal sensors belonging to respective groups.

### <Eighth Mode>

The display method according to any one of the first to seventh modes, including a step of displaying time series data for degree of abnormality of the target, by giving information indicating respective groups in a time range in which the respective groups indicate an abnormality,

### <Ninth Mode>

As in the display device according to the second aspect described above.

### <Tenth Mode>

As in the program according to the third aspect described above.

It is to be noted that the entire disclosed content of the abovementioned Patent Literature is incorporated herein by reference thereto. Modifications and adjustments of exemplary embodiments are possible within the bounds of the entire disclosure (including the scope of the claims) of the present invention, and also based on fundamental technological concepts thereof. Furthermore, various combinations and selections of various disclosed elements (including respective elements of the respective claims, respective elements of the respective exemplary embodiments, respective elements of the respective drawings, and the like) are possible within the scope of the entire disclosure of the present invention. That is, the present invention clearly includes every type of transformation and modification that a person skilled in the art can realize according to the entire disclosure including the scope of the claims and to technological concepts thereof. In particular, with regard to numerical ranges described in the present specification, arbitrary numerical values and small ranges included in the relevant ranges should be interpreted to be specifically described even where there is no particular description thereof.

### REFERENCE SIGNS LIST

10, 100, 300 display device
11 state information collection part
12 analysis model acquisition part
13 abnormality judging part
14 history information generation part
15 clustering part
16 cluster hierarchical structuring part
17 causal relationship acquisition part
18 output part
19 abnormality detection part
20 device to be analyzed
21 sensor
110 computer
111 CPU (Central Processing Unit)
112 main memory
113 storage device
114 input interface
115 display controller
116 data reader/writer
117 communication interface
118 input device
119 display device
120 storage medium
121 bus
200 system to be analyzed

What is claimed is:

1. A display method, comprising:
determining, as an abnormal sensor, a sensor having an abnormal value with respect to each of a plurality of sensors provided in a target;
clustering said determined abnormal sensors to belong to any of a plurality of groups;
determining a hierarchy among said plurality of groups; and
associating, with said abnormal sensor(s), symbol(s) capable of differentiating groups to which said abnormal sensor(s) belongs, and using said symbol(s) to present to a user said abnormal sensor(s) together with information indicating hierarchical relationships among groups.

2. The display method according to claim 1, wherein hierarchy among said plurality of groups is a hierarchy determined based on causal relationships among said plurality of groups.

3. The display method according to claim 2, wherein causal relationships among said plurality of groups are determined based on causal relationships among abnormal sensors belonging to said plurality of groups.

4. The display method according to claim 1, wherein said symbol is capable of distinguishing before/after abnormality starting time estimated with a group to which an abnormal sensor(s) corresponding to a relevant symbol(s) belongs.

5. The display method according to claim 1, wherein, in presenting to the user, information indicating range of abnormality time estimated with respective groups is further presented to the user.

6. The display method according to claim 1, wherein, in presenting to the user, said symbols are presented to the user being superimposed on a diagram indicating said target.

7. The display method according to claim 1, comprising indicating at least one selected from the class consisting of: information indicating hierarchical relationship(s) of said plurality of groups, and information indicating causal relationship(s) among abnormal sensors belonging to respective groups.

8. The display method according to claim 1, comprising displaying time series data for degree of abnormality of said target, by giving information indicating respective groups in a time range in which respective groups indicate an abnormality.

9. A display device comprising:
a processor and a memory, wherein the processor executes:
determining, as an abnormal sensor, a sensor having an abnormal value with respect to each of a plurality of sensors provided in a target;
clustering said determined abnormal sensor(s) to belong to any of a plurality of groups;
determining a hierarchy among said plurality of groups; and
associating, with said abnormal sensor(s), symbol(s) capable of differentiating groups to which said abnormal sensor(s) belongs, and uses said symbol(s) to present to a user said abnormal sensors(s) together with information indicating hierarchical relationships among groups.

10. A non-transitory computer readable storage medium recording a program, wherein
the program executes on a computer:
a process of determining, as an abnormal sensor, a sensor having an abnormal value with respect to each of a plurality of sensors provided in a target;
a process of clustering said determined abnormal sensor(s) to belong to any of a plurality of groups;
a process of determining a hierarchy among said plurality of groups; and
a process of associating, with said abnormal sensor(s), symbol(s) capable of differentiating groups to which said abnormal sensor(s) belongs, and using said symbols to present to a user said abnormal sensor(s) together with information indicating hierarchical relationships among groups.

11. The display device according to claim 9, wherein hierarchy among said plurality of groups is a hierarchy determined based on causal relationships among said plurality of groups.

12. The display device according to claim 11, wherein causal relationships among said plurality of groups are determined based on causal relationships among abnormal sensors belonging to said plurality of groups.

13. The display device according to claim 9, wherein said symbol is capable of distinguishing before/after abnormality starting time estimated with a group to which an abnormal sensor(s) corresponding to a relevant symbol(s) belongs.

14. The display device according to claim 9, wherein, in presenting to the user, information indicating range of abnormality time estimated with respective groups is further presented to the user.

15. The display device according to claim 9, wherein, in presenting to the user, said symbols are presented to the user being superimposed on a diagram indicating said target.

16. The display device according to claim 9, comprising indicating at least one selected from the class consisting of: information indicating hierarchical relationship(s) of said plurality of groups, and information indicating causal relationship(s) among abnormal sensors belonging to respective groups.

17. The display device according to claim 9, comprising displaying time series data for degree of abnormality of said target, by giving information indicating respective groups in a time range in which respective groups indicate an abnormality.

18. The storage medium according to claim 10, wherein hierarchy among said plurality of groups is a hierarchy determined based on causal relationships among said plurality of groups.

19. The storage medium according to claim 18, wherein causal relationships among said plurality of groups are determined based on causal relationships among abnormal sensors belonging to said plurality of groups.

20. The storage medium according to claim 10, wherein said symbol is capable of distinguishing before/after abnormality starting time estimated with a group to which an abnormal sensor(s) corresponding to a relevant symbol(s) belongs.
